(19) United States
(12) Patent Application Publication
(10) Pub. No.: US 2024/0255671 A1
(43) Pub. Date: Aug. 1, 2024

(54) ESTIMATION OF ELECTROMAGNETIC TOOL DETECTION CAPABILITY IN THREE-DIMENSIONAL FORMATION

(71) Applicant: Baker Hughes Oilfield Operations LLC, Houston, TX (US)

(72) Inventors: Nikolay Velker, Novosibirsk (RU); Gleb Dyatlov, Novosibirsk (RU); Sergey Martakov, Spring, TX (US)

(21) Appl. No.: 18/422,465

(22) Filed: Jan. 25, 2024

Related U.S. Application Data
(60) Provisional application No. 63/481,599, filed on Jan. 25, 2023.

(51) Int. Cl. G01V 3/20; E21B 49/00

(52) U.S. Cl. CPC G01V 3/20; E21B 49/00; E21B 2200/20

(57) ABSTRACT

A downhole system performs a method of operating a downhole device. The downhole system includes a downhole device configured to obtain measurements of a formation parameter at a measure point along a trajectory of the downhole device, and a processor. The processor defines an initial volume surrounding the downhole device, calculates a first radial parameter value using a predetermined formation parameter value distribution in the initial volume, the first radial parameter value representing a distance from the measure point and defining a volume of investigation, and performs the operation of the downhole device using the volume of investigation.

### CROSS REFERENCE TO RELATED APPLICATIONS

This application claims the benefit of an earlier filing date from U.S. Provisional Application Ser. No. 63/481,599, filed Jan. 25, 2023, the entire disclosure of which is incorporated herein by reference.

### BACKGROUND

In the oil and gas industry, a resistivity of a formation can be monitored to facilitate decision-making and geo-steering. Resistivity may be obtained using an induction tool or another electromagnetic (EM) tool. Generally, the induction tool transmits an electromagnetic field into the formation and measures a multi-component magnetic field induced by the currents in the formation. The measured magnetic field is used to determine apparent resistivity values and/or azimuthal signals. Through an inversion process, a resistivity model is obtained from these determined values or directly from the measured multi-component magnetic field. The resistivity model that is obtained by inversion fills a whole space. Measured responses from the resistivity model that are remote from the EM tool have increased levels of uncertainty and thus be used with caution when making geo-steering decisions. Evaluating a volume within the media that contributes the most to the measured responses of the EM tool improves the geo-steering process. Accordingly, there is a desire for a system and method of evaluating a volume for its levels of contribution to the geo-steering process.

### SUMMARY

In an embodiment, a method of operating a downhole device is disclosed. The method includes obtaining, using the downhole device, measurements of a formation parameter at a measure point along a trajectory of the downhole device, defining an initial volume surrounding the downhole device, calculating a first radial parameter value using a predetermined formation parameter value distribution in the initial volume, the first radial parameter value representing a distance from the measure point and defining a volume of investigation, and performing the operation of the downhole device using the volume of investigation.

In another embodiment, a downhole system is disclosed. The downhole system includes a downhole device configured to obtain measurements of a formation parameter at a measure point along a trajectory of the downhole device, and a processor. The processor is configured to define an initial volume surrounding the downhole device, calculate a first radial parameter value using a predetermined formation parameter value distribution in the initial volume, the first radial parameter value representing a distance from the measure point and defining a volume of investigation, and perform the operation of the downhole device using the volume of investigation.

### BRIEF DESCRIPTION OF THE DRAWINGS

The following descriptions should not be considered limiting in any way. With reference to the accompanying drawings, like elements are numbered alike:

FIG. 1 shows a downhole system in an illustrative embodiment;

FIG. 2 shows a depth of detection tube associated with an electromagnetic (EM) tool of the downhole system, in an illustrative embodiment;

FIG. 3 shows an initial volume which is used to generate a volume of investigation (VOI) of the EM tool using a skin depth based approach;

FIG. 4 shows a flow chart of a method for determining the VOI from the initial volume using the average skin depth as a criteria;

FIG. 5 shows a volume of investigation determined using the skin depth based approach of FIG. 4;

FIG. 6 shows an initial volume suitable for use in determining a volume of investigation (VOI) using a response-based approach;

FIG. 7 is a diagram depicting a series of stages that are performed to determine the volume of investigation from the initial volume in the response-based approach;

FIG. 8 shows a flowchart of the response-based approach for determining the shape of the volume of investigation from the initial volume;

FIG. 9 shows an illustrative volume of investigation that can be generated from the initial volume using the response-based approach;

FIG. 10 is a diagram depicting a series of stages that are performed to determine the volume of investigation from the initial volume using the response-based approach, in an alternate embodiment;

FIG. 11 shows a flowchart of the response-based approach for determining the shape of the volume of investigation from the initial volume, in an alternate embodiment;

FIG. 12 is a diagram depicting stages for constructing a volume of investigation using a generalized response-based approach;

FIG. 13 shows a flowchart illustrating a method for determining the volume of investigation using the generalized response-based approach of FIG. 12;

FIG. 14 shows a model of a two-layer medium with an electromagnetic tool disposed therein;

FIG. 15 shows a flowchart of a method for determining a limit for a radial detection range of the electromagnetic tool using the two-layer model shown in FIG. 14;

FIG. 16 shows a view of a depth of detection tube (DoD tube) along a longitudinal axis of the DoD tube, in an illustrative embodiment; and

FIG. 17 shows a flowchart of a method for calculating radial parameters of the DoD tube, in an embodiment.

### DETAILED DESCRIPTION

A detailed description of one or more embodiments of the disclosed apparatus and method are presented herein by way of exemplification and not limitation with reference to the Figures.

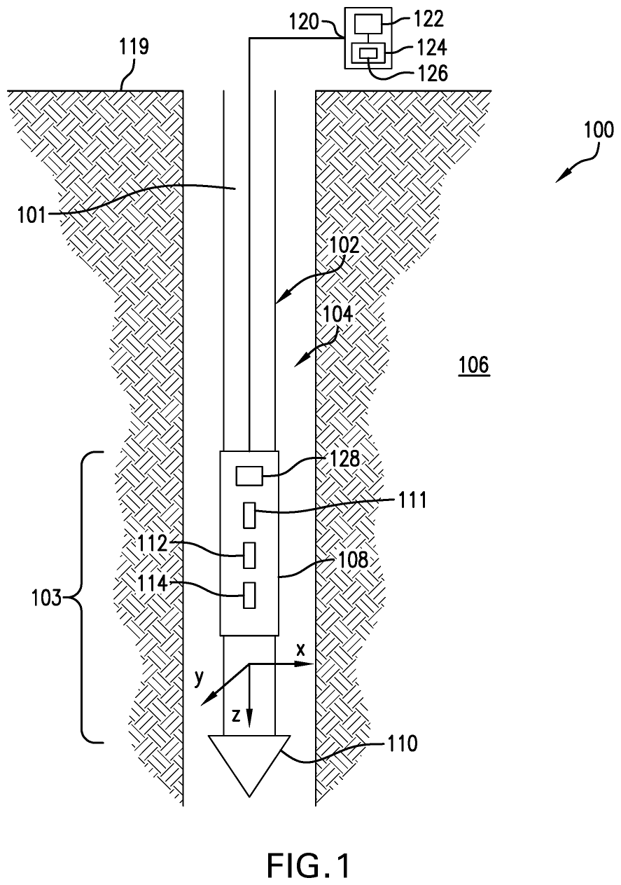

Referring to FIG. 1, a downhole system 100 is shown in an illustrative embodiment. The downhole system 100 includes a work string 102 disposed in a borehole 104 penetrating a formation 106. The work string 102 includes drill pipes 101 and a bottom hole assembly (BHA) 103 at a downhole end of the work string 102. An electromagnetic tool (EM tool) 108 is located in the BHA 103. The EM tool 108 can include one or more transmitters 112 for transmitting an electromagnetic signal into the formation 106 to generate currents in the formation 106 and one or more receivers 114 for receiving a formation response generated by the currents. The one or more transmitters 112 can be tri-axial transmitters aligned along x-, y- and z-axes of the work string 102, and the one or more receivers 114 can be tri-axial receivers aligned along the x-, y-, and z-axes of the work string 102. In alternative embodiments, the transmitters 112 can be single-axis or any suitable transmitter type and the receivers 114 can be single-axis or any suitable receiver type. The work string 102 can also include a drill bit 110 at a downhole end of the BHA 103 for drilling the borehole 104. The EM tool 108 can be located in the BHA 103 near the drill bit 110 or away from the drill bit. In various embodiments, the BHA 103 includes a plurality of modular subs and the EM tool 108 is disposed in either one sub or across multiple subs.

The work string 102 is in communication with a control unit 120 at a surface location 119 and can transmit data obtained by the EM tool 108 to the control unit 120 for processing. The control unit 120 includes a processor 122 and a computer readable storage medium 124. The computer readable storage medium 124 includes one or more programs 126 that, when accessed by the processor 122, enable the processor 122 to perform various calculations disclosed herein for determining a model of formation resistivity from measurements (measured data) obtained using the one or more transmitters 112 and the one or more receivers 114. The processor 122 can operate the one or more transmitters 112 to generate currents in the formation 106 and the one or more receivers 114 to measure a response generated by the currents (formation response). The processor 122 can perform an inversion on the measurements obtained from the formation 106 surrounding the work string 102 and determine resistivity distribution ρ(r) within the formation 106. The processor 122 can further control operation of the work string 102 to perform geo-steering of the work string 102 based on the resistivity distribution using the methods disclosed herein.

The BHA 103 can also include a downhole processor 128. In various embodiments, the downhole processor 128 can control operation of the transmitters and receivers and control operation of downhole devices for implementing geo-steering at the work string 102. The downhole processor can also perform pre-processing of the measurements from the EM tool 108 prior to sending the measured data to the control unit 120 at the surface location. Sending the measured data to the control unit 120 can be performed using a telemetry system 111. The telemetry system 111 can be a mud pulse telemetry system, an electromagnetic telemetry system, an acoustic telemetry system, or a wired pipe telemetry system. In various embodiments, the processor 122 of the control unit 120 and the downhole processor 128 can cooperatively perform the methods disclosed herein. In one more embodiment the downhole processor 128 can perform the methods disclosed herein without involving the processor 122 in the control unit 120 (geo-steering).

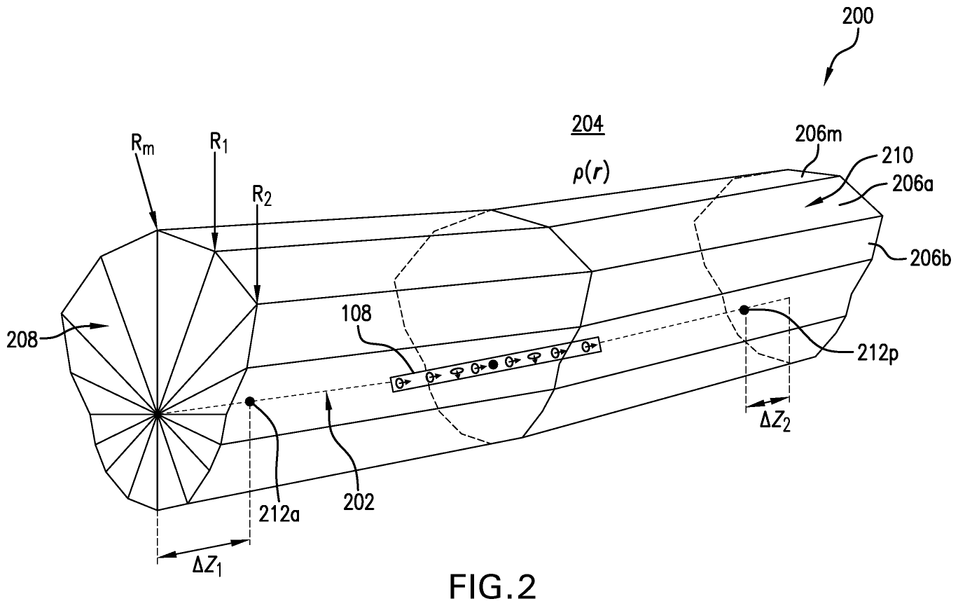

FIG. 2 shows a depth of detection tube (DoD tube 200) associated with the EM tool 108, in an illustrative embodiment. The EM tool 108 is shown extending along a trajectory 202 passing through the medium 204 and being drilled by the work string 102. The trajectory 202 includes a sequence of measure points 212a-212p extending along the trajectory 202. Each measure point corresponds to a position (recorded as a measured depth (MD) in the log, also known as a logging point) of the EM tool 108 on the trajectory 202 where the acquired data is assigned. The medium 204 is a model of a resistivity of the formation 106 and is shown having a resistivity distribution ρ(r). The medium 204 and the resistivity distribution can be created using a simulated resistivity model or can be based on an inversion of resistivity measurements made by the EM tool 108 using an inversion algorithm. The resistivity measurements used for the inversion can be recorded in an offset well. The trajectory 202 coincides with a longitudinal axis of the EM tool 108, a longitudinal axis of the DoD tube 200, and/or a longitudinal axis of the borehole in which the EM tool 108 resides. The DoD tube 200 surrounds the longitudinal axis of the EM tool 108 and surrounds the longitudinal axis of the borehole and the trajectory 202. The DoD tube 200 forms a formation material tube around the borehole. The borehole forms an inner bore of the DoD tube 200. Depending on the electromagnetic properties of the formation material, the shape of the outer surface of a cross section of the DoD tube perpendicular to the longitudinal axis of the tool and the longitudinal axis of the borehole, respectively, forms a circle (homogenous resistivity distribution over the formation material), or forms an irregularly shape. The methods disclosed herein determine the shape of the outer surface of the DoD tube 200.

The DoD tube 200 is a parametrically constructed volume over the measure points 212a-212p of the trajectory 202 and describes the radial detection capability of the EM tool 108 at each of the measure points 212a-212p as well as the forward detection range at a last point of the trajectory 202. The DoD tube 200 is a parametric approximation of a plurality of volumes of investigation (VOI), each surrounding one measure point or a set of measure points 212a-212p of the trajectory 202. Each VOI meets a certain criterion indicative of the detecting capabilities of the EM tool 108. Each VOI is created by starting with an initial volume within the medium 204 that is greater than a sensitivity range of the EM tool 108 and modifying or reducing the initial volume using the methods disclosed herein. The resistivities within the volume of investigation can be used subsequently for geo-steering of the work string 102 or other downhole operations. The DoD tube 200 defines the outer boundary (outer surface) of the volume of investigation. The DoD tube 200 refers to the outer 3-D shape of the outer surface of the volume of investigation. Knowing the DoD tube 200 improves the level of confidence in inversion models (resistivity or formation models) resulting from an inversion of resistivity measurements. The DoD tube 200 can be used to identify invalid inversion results and to validate inversion models. Being able to validate inversion models is particularly important in geo-steering applications where steering decisions are made based on inversion models while drilling a borehole.

The DoD tube 200 includes parametric surfaces surrounding the trajectory 202 of the EM tool 108. In particular, the DoD tube 200 includes piecewise circumferential surfaces 206a-206m or planes that represent the radial sensitivity range of the EM tool 108. A first axial surface 208 and a second axial surface 210 of the VOI are estimates of the backward and forward detection ranges of the EM tool 108, respectively.

For each measure point, a geometry for a cross section of the DoD tube 200 is determined by defining a set of radial parameters R₁, . . . , Rₘ. The surface of the DoD tube 200 at any arbitrary point of the trajectory 202 between any two neighboring measure points can be determined by interpolation of the parametric surfaces determined at the neighboring points. Additionally, a volume of investigation at an intermediate point between two neighboring measure points can be determined via interpolation of the VOIs at the measure points. Parameters ΔZ₁ and ΔZ₂ are determined at the first measure point 212a and the last measure point 212p, respectively, and represent the estimated average axial detection capabilities of the EM tool 108.

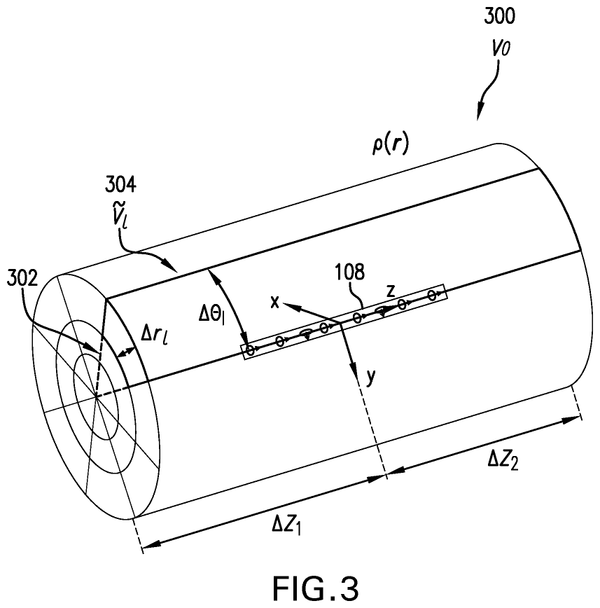

The DoD tube 200 is a parametric approximation of a plurality of volumes of investigation built at the measure points along the trajectory 202 of the tool. A volume of investigation (VOI) is a union of a number of small cells surrounding the EM tool and satisfying a selected criterion. A VOI can be determined using various methods. In a first method (referred to herein as a “skin depth based approach”), the VOI is determined based on a skin depth criterion. An initial volume is segmented into a plurality of sub-volumes and the sub-volumes are retained or removed from the VOI based on the skin depth criterion. Details of the first method are discussed herein with respect to FIGS. 3-5.

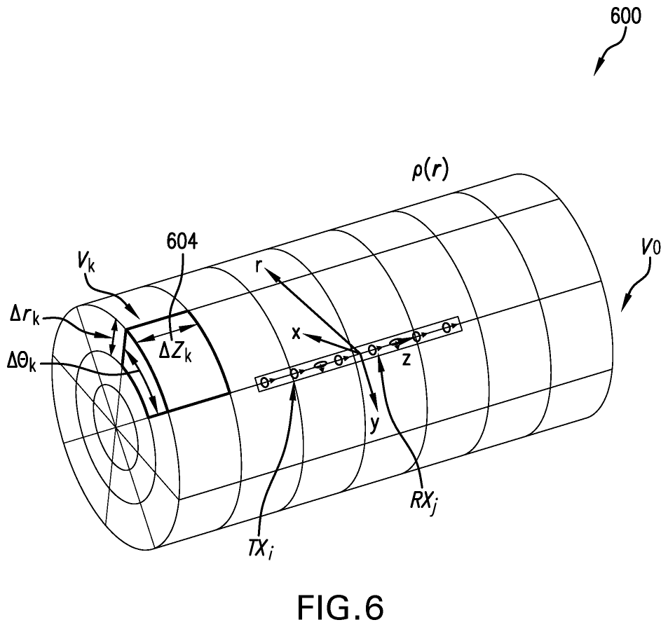

In a second method (referred to herein as a “response-based approach”), the VOI can be calculated by creating a set of reduced volumes from the initial volume, comparing modified tool responses (formation response based on a reduced volume) from the reduced volumes to a tool response (formation response based on the initial volume) from the initial volume and selecting one of the reduced volumes based on the comparison. Details of the second method are discussed herein with respect to FIGS. 6-11.

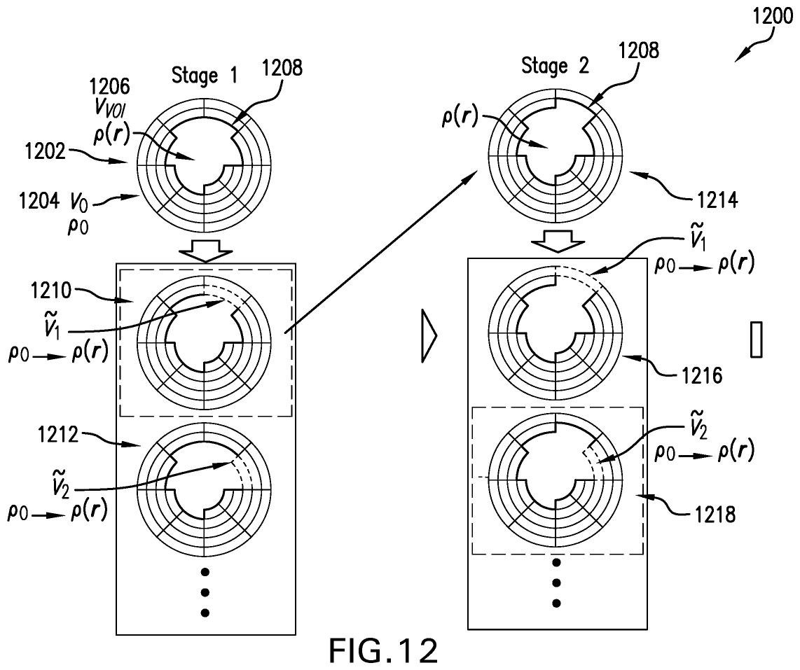

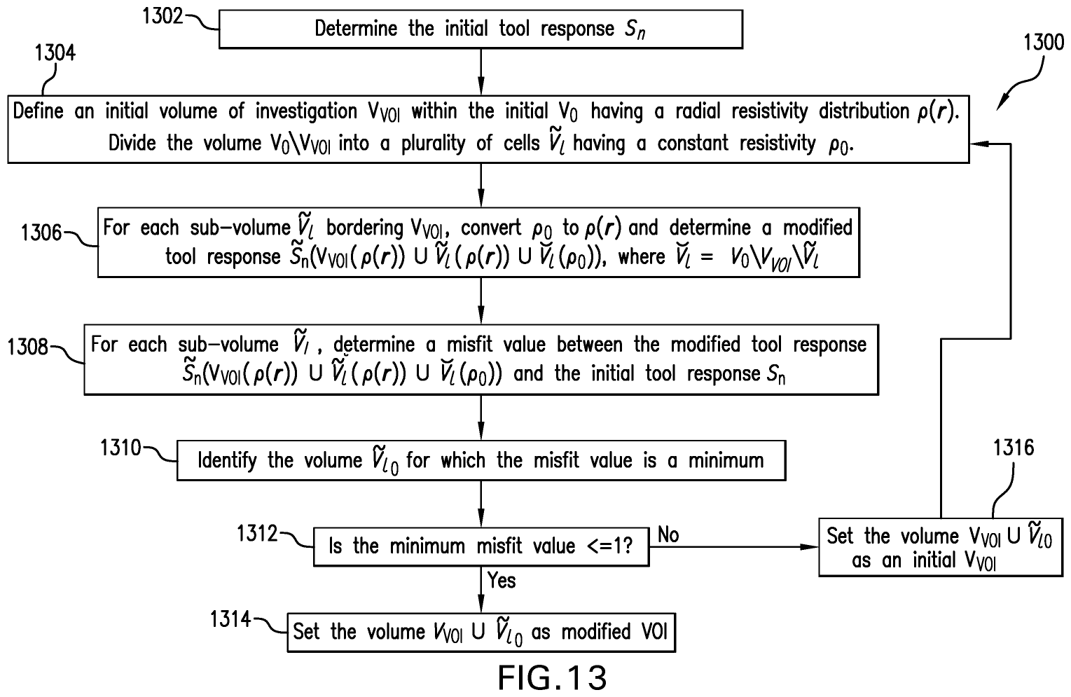

In a third method (referred to herein as a “generalized response-based approach”), the VOI can be calculated starting with an initial volume having a first resistivity distribution and the initial volume of investigation, determined by the response-based approach, within the initial volume having a second resistivity distribution. A resistivity of a cell of the initial volume is switched from the first resistivity to the second resistivity and the effects of the change on the response is determined. Alternatively, the resistivity of the cell of the initial volume can be switched from the first resistivity to any selected resistivity and the effects of the change evaluated. Details of the third method are discussed herein with respect to FIG. 12-13.

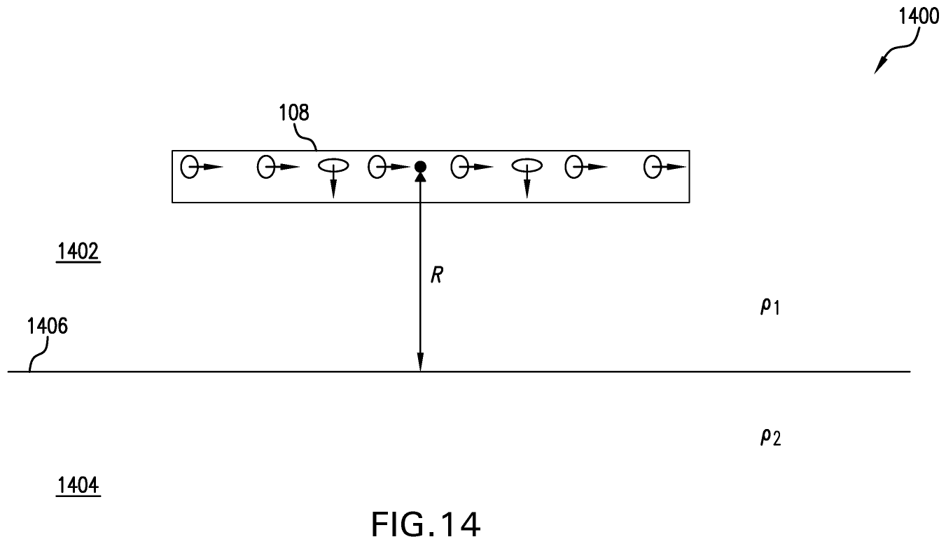

In yet another approach (referred to herein as “field decay-based approach”), a layered formation model or resistivity model is used. A limit value of the radial detection range is determined by comparing a first set of responses for the EM tool 108 in a homogeneous medium to a second set of responses for the EM tool 108 disposed in the two-layer model. A misfit value is determined between the second set of responses and the first set of responses. A misfit threshold is determined and the limit of the radial detection range of the EM tool is found when the misfit threshold is reached. A radial parameter limiting the VOI is determined using the limit of the radial detection range of the EM tool, a magnetic field decay function and a resistivity distribution in an initial volume. Details of the fourth method are discussed herein with respect to FIG. 14-17.

All four approaches are disclosed herein with respect to resistivity measurements. However, the approaches are not limited to resistivity measurements. In an alternative embodiment, the approaches can be applied to conductivity measurements or other formation parameter measurements of interest or formation parameter distribution for which determination of a DoD tube may be beneficial.

FIG. 3 shows an initial volume 300 (V₀) which is used to generate a VOI using the skin depth based approach. For illustrative purposes, the initial volume 300 (V₀) is shown as a cylindrical volume located at a measure point of the trajectory 202 of the EM tool 108 and the borehole. It is to be understood however that the initial volume can have any shape, in various embodiments. The initial volume 300 resides within a resistivity model of the formation (predetermined resistivity distribution). The radial extent of the initial volume 300 V₀ is selected to exceed a known upper limit of the radial detection range of the EM tool 108. The upper limit of the radial detection range is roughly equivalent to the tool spacing of the EM tool 208, wherein the tool spacing is the distance between the outermost transmitter or receiver at a first end (e.g., uphole end) of the EM tool and the outermost transmitter or receiver at a second end (e.g. downhole end), opposite the first end. The parameters ΔZ₁ and ΔZ₂ are selected to exceed known upper limits for direct and backward detection ranges of the EM tool correspondingly. A mesh is constructed that segments the initial volume 300 V₀ into a plurality of angular sectors (such as angular sector 302), each angular sector having sub-volumes stacked in the radial direction, as illustrated by sector sub-volume 304 \tilde{V}ₗ. Each angular sector m relates to a different angular position in a plane perpendicular to the trajectory 202, wherein the angular position refers to an angle around the trajectory. Each sub-volume has a radial extent Δrₗ, axial length ΔZ₁+ΔZ₂ and a circumferential extent Δθₗ, also referred to herein as angular extent. The radial extent Δrₗ of each sub-volume \tilde{V}ₗ is selected to be significantly smaller than a minimal skin depth within the sub-volume. ΔZ₁ and ΔZ₂ may be equal values or may be different values. The skin depth depends on the frequency of the transmitted electromagnetic signal of the EM tool 208 and the electromagnetic properties of the formation (resistivity permeability). For typical formation resistivities and typical EM tool transmitted frequencies (20 kHz to 2 MHz) the skin depth is in the range of centimeters to several meters.

The average value of the skin depth δₗ within a selected sub-volume \tilde{V}ₗ can be calculated using the expression shown in Eq. (1):

$${δ}_{l} = \frac{1}{\tilde{{V}_{l}}} \int \int {\int }_{\tilde{{V}_{l}}} \sqrt{\frac{ρ ( r )}{π \cdot f \cdot μ}} d V \qquad Eq . ( 1 )$$

where ρ(r) is the resistivity distribution of the resistivity model, r is the radius vector of an arbitrary point of the model, f is a frequency at which a signal is generated by a transmitter of the EM tool 108, and μ is a permeability of the resistivity model. The sub-volume \tilde{V}l of the initial volume resides in the resistivity model.

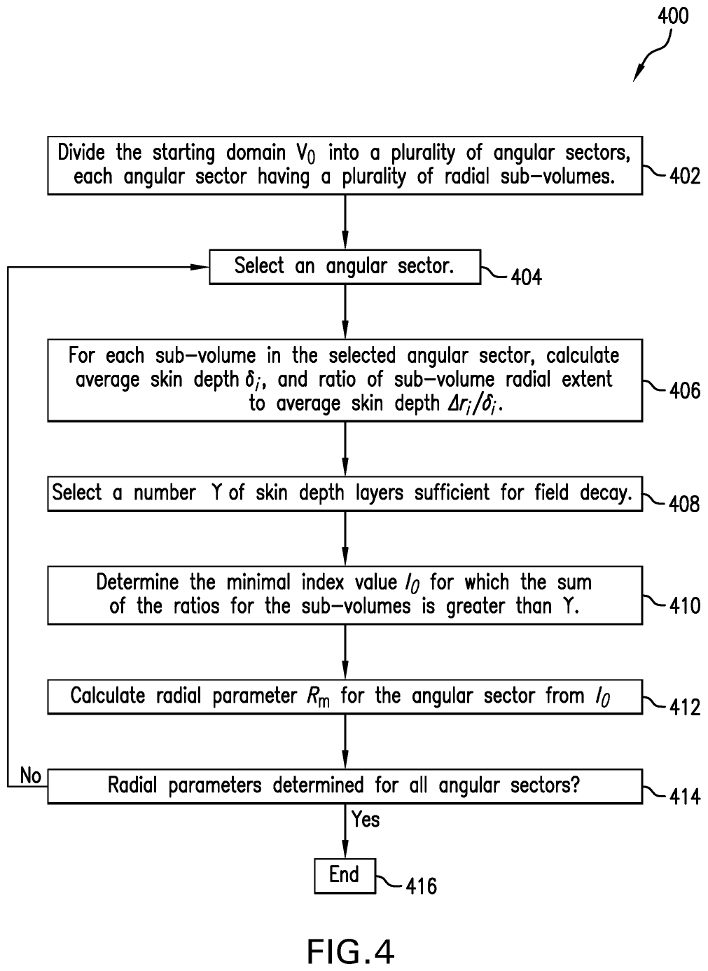

FIG. 4 shows a flow chart 400 of a method for determining the VOI from the initial volume 300 using the average skin depth as a criterion. In box 402, the initial volume 300 is divided into a mesh including a plurality of angular sectors, with each angular sector including a plurality of sub-volumes layered in the radial direction. In box 404, an angular sector is selected. In box 406, the average skin depth δₗ is calculated for each sub-volume within the selected angular sector, and a ratio Δrₗ/δₗ is determined for each sub-volume in the selected angular sector, wherein Δrₗ is the radial extent of the sub-volume. The radial extent Δrₗ may be the same for all sub-volumes l, or may be different for different sub-volumes l.

In box 408, a number γ (e.g., 3 to 4) of skin depth layers is defined or chosen that is sufficient for producing a given decay (equivalent a signal decay related to 3 to 4 times the shin depth) of the electromagnetic field in the radial direction. In box 410, a number of sub-volumes within a sector that meet the criterion of γ skin depth layers is determined. In particular, a sub-volume upper index l₀ is determined using the ratios from the sub-volumes. The sub-volume upper index l₀ is determined by accumulating sub-volumes in the radial direction extending from the center of the initial volume 300. These sub-volumes are added sequentially in the radial direction until the criterion shown in Eq. (2) is met:

$${\sum }_{l = 1}^{{l}_{0}} \frac{Δ {r}_{l}}{{δ}_{l}} \geq γ > {\sum }_{l = 1}^{{l}_{0} - 1} \frac{Δ {r}_{l}}{{δ}_{l}} \qquad Eq . ( 2 )$$

where l=1 is the index value for the radially inner most sub-volume. Thus, the minimal index value l₀ is determined for which the sum of the ratios for the sub-volumes \tilde{V}₁ to \tilde{V}ₗ_{₀} is greater than γ. In box 412, the sub-volume upper index l₀ is used to determine the radial parameter Rₘ of the m angular sector. In particular, the radial parameter Rₘ is the radial extent of the l₀ accumulated sub-volumes. The radial parameter Rₘ is calculated using the equation of Eq. (3):

$${R}_{m} = {\sum }_{l = 1}^{{l}_{0}} Δ {r}_{l} \qquad Eq . ( 3 )$$

In box 414, a check is made whether the radial parameters Rₘ have been determined for all angular sectors. If no, the method returns to box 404, in which another angular sector is selected. If yes, the method proceeds to box 416, where the method ends. The VOI is the union of the sub-volumes selected by this method.

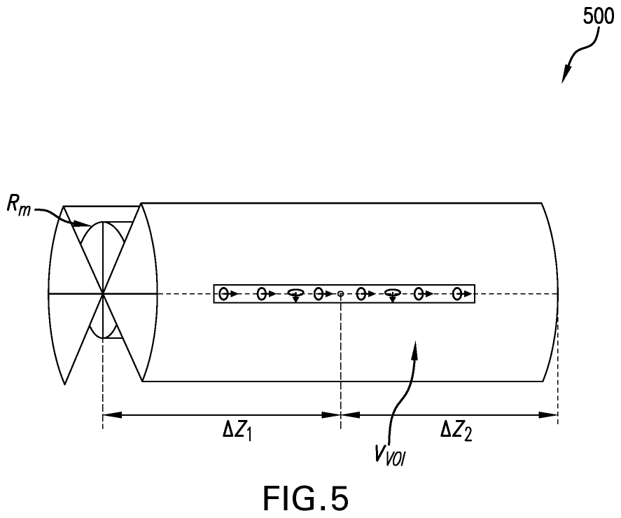

FIG. 5 shows a volume of investigation 500 determined using the skin depth based approach of FIG. 4. FIG. 5 shows a union of sub-volumes that form the volume of investigation. The radial extent of the sub-volumes determines a resolution of the volume of investigation 500.

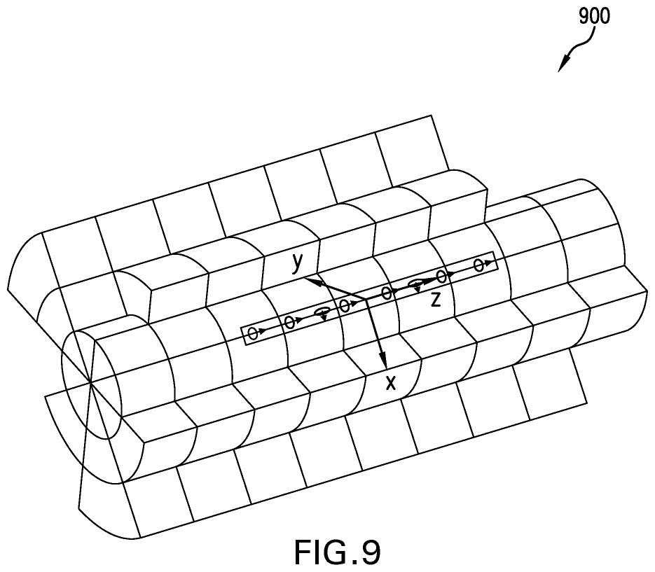

FIG. 6 shows an initial volume V₀ 600 suitable for use in determining a VOI using a response-based approach. The initial volume V₀ 600 is a volume that extends radially beyond the radial detection range of the EM tool 108. For illustrative purposes, the initial volume V₀ 600 is a cylindrical volume, although any shape can be used in various embodiments. A mesh divides the initial volume 600 into the cell volumes or cells Vₖ, k=1, . . . , K. A k^{th} cell Vₖ 604 is highlighted in FIG. 6 for illustrative purposes. The k^{th} cell Vₖ has an axial length ΔZₖ, a radial extent Δrₖ and an angular extent Δθₖ. Each cell is located in an angular sector m. Each angular sector m relates to a different angular position in a plane perpendicular to the trajectory 202. The angular position refers to an angle around the trajectory 202. The cell can be considered separately or can be combined to form sub-volumes \tilde{V}₁, \tilde{V}₂, . . . of the initial volume V₀ (as shown in FIG. 9). The radial extent Δrₖ may be the same for all cells k, or may be different for different cells k. The parameters that describe the DoD tube are based on the parameters of all k cells including the position of the k^{th} cell (radius vector rₖ) to a representative point of the k^{th} cell (such as to the center of the cell), the axial length (ΔZₖ), the radial extent (Δrₖ), and the angular position of the k^{th} call and the angular extent Δθₖ.

The initial volume 600, the EM tool 108, a plurality (p=1, . . . , P) of transmitters TX₁, . . . , TX_{P} and a plurality (s=1, . . . , S) of receivers RX₁, . . . , RX_{S} are centered along the trajectory 202. The plurality of transmitters TX₁, . . . , TX_{P} operate at an operating frequency f and generate electromagnetic fields (electromagnetic vector fields) in the medium. The electromagnetic fields may be harmonic electromagnetic fields (i.e., E˜e^{-iωt} and H˜e^{-iωt}). A complex amplitude of the magnetic field Hₚ(r_{RXs}) (magnetic vector field) received at the s^{th} receiver (RXₛ) as a result of the electromagnetic fields generated in the medium by the p^{th} transmitter (TXₚ) can be described using a generalization of the Biot-Savart law, as shown in Eq. (4):

$${H}_{p} ( {r}_{RXs} ) = {H}_{0 , p} ( {r}_{RXs} ) + \frac{1}{4 π} {\int }_{{R}^{3}} dV \frac{{J}_{p} ( r ) \times ( r - {r}_{RXs} )}{{\vert r - {r}_{RXs} \vert}^{3}} \qquad Eq . ( 4 )$$

where H_{0,p} (r_{RXs}) is the complex amplitude of a direct field (direct vector field) emitted by transmitter TXₚ and received at receiver RXₛ, and the integral term is the amplitude of an anomalous field generated by currents and/or charges that are induced in the medium 204. The term Jₚ(r) is a total current density and contains a sum of the complex amplitudes of conduction and displacement current density vectors. The total current density is defined in Eq. (5):

$${J}_{p} ( r ) = ( 1 / ρ ( r ) - i ω ε ) {E}_{p} ( r ) \qquad Eq . ( 5 )$$

where the electric field Eₚ(r) (electric vector field) generated by the p^{th} transmitter and is obtained from Maxwell's equations. ω is the angular frequency (ω=2πf) and ε is the permittivity of the surrounding formation.

The receiver RXₛ records a voltage Uₚₛ that is caused by the electric field Eₚ(r) generated at transmitter TXₚ. By approximating the sensors of the EM tool as dipoles, the complex amplitude of the voltage Uₚₛ across the receiver is described by Eq. (6):

$${U}_{ps} = {U}_{0 , ps} + {\int }_{{R}^{3}} dV {u}_{p} ( {r}_{RXs} , r ) \qquad Eq . ( 6 )$$

where U_{0,ps}=i·ω·μ·mₛ·H_{0,p}(r_{RXs}), with mₛ being the complex vector of equivalent RXₛ moment (dipole moment). In the integral on the right-hand side of Eq. (6), the term:

$${u}_{p} ( {r}_{RXs} , r ) = \frac{i \cdot ω \cdot μ}{4 π} \frac{{J}_{p} ( r ) \times ( r - {r}_{RXs} )}{{\vert r - {r}_{RXs} \vert}^{3}} \cdot {m}_{s} \qquad Eq . ( 7 )$$

is the contribution density in the voltage from the total currents in the medium.

At each measure point along the trajectory, the EM tool 108 registers a set of responses Sₙ, n=1, . . . , N (also referred to herein as tool responses, or signal responses). A response Sₙ is represented as a transformation from a given sequence of voltages Uₚₛ, p=0, 1, . . . , P and s=0, 1, . . . , S denoted as {Uₚₛ}ₙ. The response Sₙ of the tool can then be represented as shown in Eq. (8):

$${S}_{n} = {f}_{n} ( {\{ {U}_{ps} \}}_{n} ) \qquad Eq . ( 8 )$$

Since the dimension of the initial volume V₀ exceeds the detection range of the EM tool, the integration over the entire space can be modified to an integration over the initial volume V₀. The response due to the contributions from the total currents from within the initial volume V₀ is denoted herein as:

$${S}_{n} = {S}_{n} ( {V}_{0} ) \qquad Eq . ( 9 )$$

Since the initial domain V₀ is segmented into individual cells Vₖ, k=1, . . . , K. Eq. (6) can be rewritten as shown in Eq. (10):

$${U}_{ps} = {U}_{0 , ps} + {\sum }_{k = 1}^{K} Δ {U}_{{V}_{{k}^{, ps}}} \qquad Eq . ( 10 )$$

$$where$$

$$Δ {U}_{{V}_{k} , ps} = {\int }_{{V}_{k}} dV {u}_{p} ( {r}_{RXs} , r ) \qquad Eq . ( 11 )$$

is the contribution from the k^{th} cell Vₖ to the voltage at the receiver RXₛ as a result of total currents generated in the cell by the transmitter TXₚ.

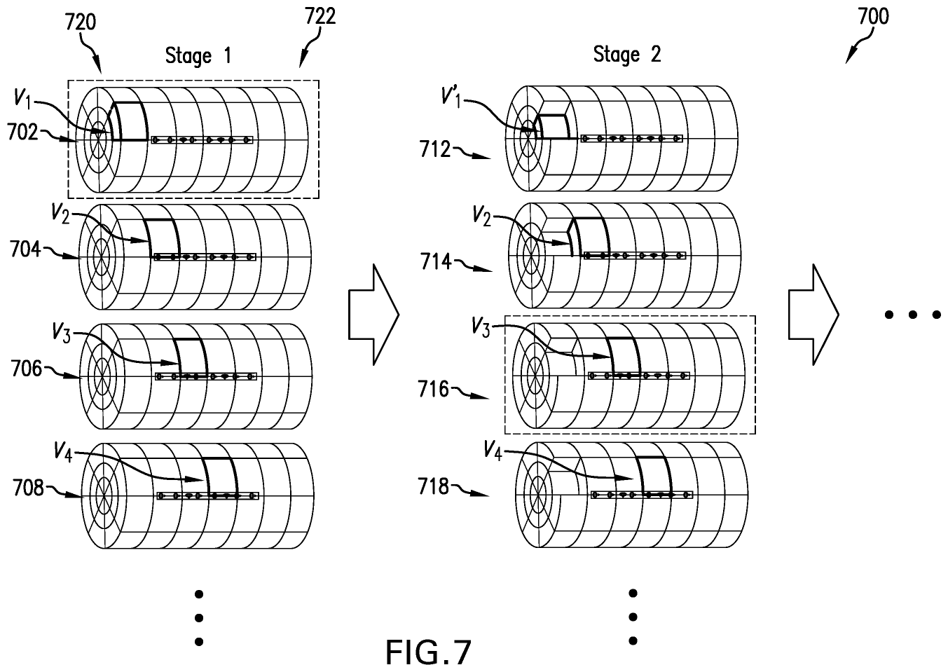

FIG. 7 is a diagram 700 depicting a series of stages that are performed to determine the V_{VOI} from the initial volume V₀, using the response-based approach, in an illustrative embodiment. A first stage (Stage 1) and a second stage (Stage 2) are shown for illustrative purposes. However, additional stages can be performed until a criterion is met. For each stage, the process is performed using individual cells V₁, V₂, . . . .

In the first stage, a plurality of cells V₁, V₂, . . . can be defined over the initial volume V₀. Each of the plurality of cells V₁, V₂, . . . are used in separate trials to determine the effect that removing the response associated with the cell has on the signal response recorded at the EM tool 108. The first trial 702 uses a first cell V₁ located at a first end 720 of the initial volume V₀ at an outermost radial location. The second trial 704 uses a second cell V₂; the third trial 706 uses a third cell V₃ and the fourth trial 708 uses a fourth cell V₄. Each of the cells are located at a radially outermost location and at a same circumferential location. The cells are arranged sequentially along the axis of the initial volume V₀ extending from the first end 720 to the second end 722. Additional cells can also be used in additional trials, although such cells are not shown in FIG. 7. Additionally, cells can be selected from different radial, circumferential and axial locations of the initial volume V₀.

For each trial, a modified tool response is calculated that results from removing the respective cell from the initial volume V₀ to define a reduced volume. The modified tool responses are compared to each other to determine which of the cells, when removed, has the least effect on the signal response. The selected cell is then removed to create an intermediate volume. This intermediate volume is then used at the second stage to begin the process again. As shown in Stage 2 of FIG. 7, the intermediate volume results from removing the first cell volume V₁ from the initial volume V₀.

In the second stage, a new plurality of cells is defined over the intermediate volume. The first trial 712 of the second stage uses a cell V′₁ that is located radially inward and adjacent to the location of the first cell V₁. The second cell V₂ (used in the second trial 714 of Stage 2), third cell V₃ (used in the third trial 716 of Stage 2), and fourth cell V₄ (used in the fourth trial 718 of Stage 2) are the same as in the Stage 1 trials. As in the first stage, additional trials can be run with other sub-volumes (not shown) during the second stage. The signal responses resulting from each trial are compared to each other to determine which cells to remove. This method then proceeds to subsequent stages (not shown) until a stopping criterion is met.

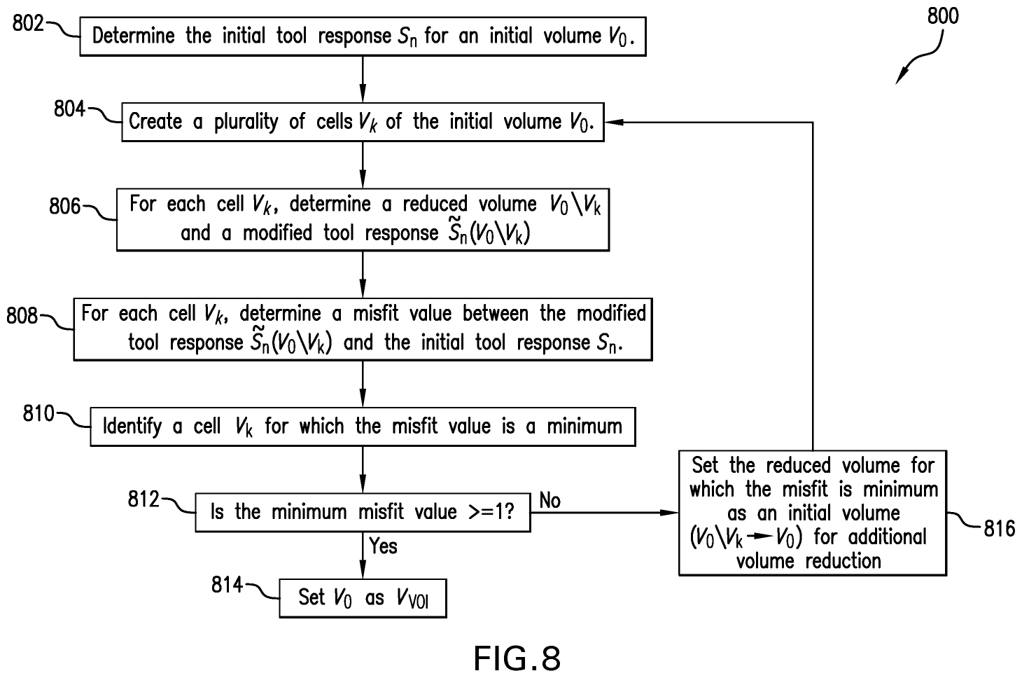

FIG. 8 shows a flowchart 800 of the response-based approach for determining the shape of the volume of investigation V_{VOI} from the initial volume V₀. In box 802, an initial tool response Sₙ (V₀) is determined for the initial volume V₀:

$${S}_{n} = {f}_{n} ( {\{ {U}_{ps} \}}_{n} ) n = 1 , … , N \qquad Eq . ( 12 )$$

In box 804, a plurality of cells Vₖ are defined over the initial volume V₀. In box 806, a plurality of modified tool responses is calculated. Each modified tool response is the tool response from a reduced volume V₀\Vₖ corresponding to the initial volume minus a respective cell. For example,

the corrected tool response for the k-th reduced volume is denoted by Eq. (13):

$${\tilde{S}}_{n} ( {V}_{0} ∖ {V}_{k} ) = {f}_{n} ( {\{ {U}_{ps} - Δ {U}_{{V}_{k} , p s} \}}_{n} ) \qquad Eq . ( 13 )$$

In box 808, a misfit value is determined for each reduced volume. The misfit value is based on a difference between the corrected tool response (\tilde{S}ₙ(V₀\Vₖ) for the trial and tool response for the initial volume (Sₙ), as shown in Eq. (14):

$${msft}_{k} = {max}_{n} ( \frac{\vert {\tilde{s}}_{n} ( {V}_{0} ∖ {V}_{k} ) - {s}_{n} \vert}{{α}_{n} \cdot \vert {S}_{n} \vert + {δ}_{n}} ) \qquad Eq . ( 14 )$$

where αₙ and δₙ are the relative and absolute tool measurement errors, respectively.

It is understood that the tool error model for the misfit calculation is only a particular example and can be chosen arbitrarily. In a generalized form the misfit value may be calculated as shown in Eq. (15):

$${msft}_{k} = ‖ W ( {S}_{n} , noise ) ( {\tilde{S}}_{n} ( {V}_{0} ∖ {V}_{k} ) - {S}_{n} ) ‖ \qquad Eq . ( 15 )$$

where W is a matrix of weights depending on an EM tool error model. In box 810, the sub-volume for which the misfit value is minimum is identified, as shown in Eq. (16):

$${msft}_{{k}_{0}} = {min}_{k} ( {msft}_{k} ) \qquad Eq . ( 16 )$$

In box 812, if the minimum misfit value is greater than or equal to 1 (msftₖ_{₀}≥1), the method proceeds to box 814. In box 814, the method ends, with the initial volume V₀ being selected as the V_{VOI} (i.e., V₀→V_{VOI}) Returning to box 812, if the minimum misfit value is less than 1, the method proceeds to box 816. In box 816, the cell having the minimum misfit value is removed to create the intermediate volume, which is used as input to the next stage. The method then returns to box 804.

FIG. 9 shows an illustrative Volume of Investigation V_{VOI} 900 that can be generated from the initial volume V₀ 600 using the response-based approach disclosed with respect to FIGS. 7 and 8. The illustrative V_{VOI} 900 is a connected space domain that surround the EM tool. The V_{VOI}, in case of response-based approach, is a union of minimal possible number of small cells Vₖ of a given shape (for example, cells of a 3D Cartesian grid or of a cylindrical grid) that provides set of the observed tool responses at a point or interval along the tool trajectory different from the total measured signals with misfit (see Eq. (16)) less than 1. A parametric definition of the DoD tube is given by a set of radial parameters R₁, . . . , Rₘ, where m is the number of angular sectors and the radial parameter values are given by the summation of the radial extends of cells in the defined volume of investigation.

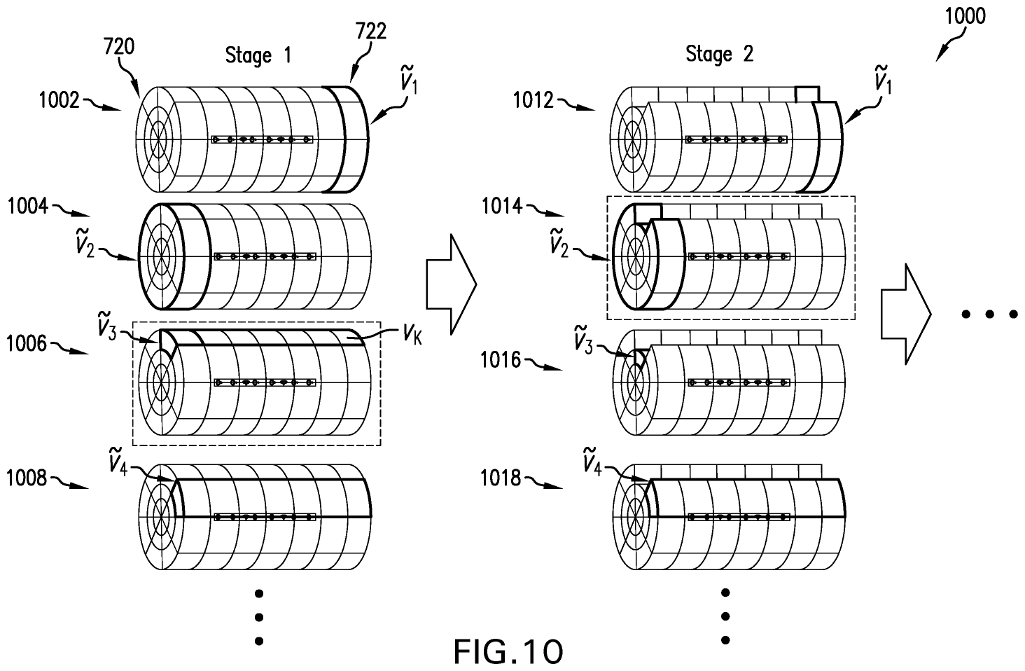

FIG. 10 is a diagram 1000 depicting a series of stages that are performed to determine the V_{VOI} from the initial volume V₀ using the response-based approach in an alternate embodiment. Cells are grouped to form sub-volumes and trials are performed using the sub-volumes. A first stage (Stage 1) and a second stage (Stage 2) are shown for illustrative purposes. However, additional stages can be performed until a criterion is met. In the first stage, a plurality of sub-volumes \tilde{V}₁, \tilde{V}₂, . . . can be defined over the initial volume V₀. A sub-volume \tilde{V}₁, \tilde{V}₂, . . . can be a union of cells.

Each of the plurality of sub-volumes \tilde{V}₁, \tilde{V}₂, . . . are used in separate trials to determine the effect that removing the response associated with the sub-volume has on the signal response recorded at the EM tool 108. The first trial 1002 uses a sub-volume \tilde{V}₁ located at the second end 722 of the initial volume V₀. The sub-volume \tilde{V}₁ is a union of cells at the same axial location at the second end 722. The second trial 1004 uses a sub-volume \tilde{V}₂ that is a union of cells at the first end 720 of the initial volume V₀. The third trial 1006 uses a sub-volume \tilde{V}₃ that is a union of cells at an outer-most radial location of the initial volume within a first angular sector. The fourth trial 1008 uses a sub-volume \tilde{V}₄ that is a union of cells at an outer-most radial location of the initial volume and within a second angular sector. Additional trials can be run using additional sub-volumes (not shown). Each angular sector m relates to a different angular position in a plane perpendicular to the trajectory 202, wherein the angular position refers to an angle around the trajectory.

For each trial, a modified tool response is calculated that results from removing the respective sub-volume from the initial volume V₀. The modified tool responses are compared to each other to determine which of the sub-volumes, when removed, has the least effect on the signal response. The selected sub-volume is then removed to create an intermediate volume. This intermediate volume is then used at the second stage to begin the process again. As shown in Stage 2 of FIG. 10, the intermediate volume is a result of removing the sub-volume V₃ from the initial volume.

In the second stage, a new plurality of sub-volumes is defined over the intermediate volume. The first trial 1012 of the second stage uses a sub-volume \tilde{V}₁ that is a union of cells at the first axial location at the second end 722, minus the cell that was removed as a result of removing sub-volume \tilde{V}₃ in the first stage. The second trial 1014 of the second stage uses a sub-volume \tilde{V}₂ that is a union of cells at the second axial location at the first end 720, minus the cell that was removed as a result of removing sub-volume \tilde{V}₃ in the first stage. The third trial 1016 of the second stage uses a sub-volume \tilde{V}₃ that is a union of cells that are now at the outer-most radial location of the first angular sector, as a result of removing the sub-volume \tilde{V}₃ in the first stage. The fourth trial 718 of the second stage uses a sub-volume \tilde{V}₄ that is a union of cells at an outer-most radial location of the initial volume and within the second angular sector. As in the first stage, additional trials can be run with other sub-volumes (not shown) during the second stage. The signal responses resulting from each trial are compared to each other to determine which sub-volume to remove. This method then proceeds to subsequent stages (not shown) until a stopping criterion is met.

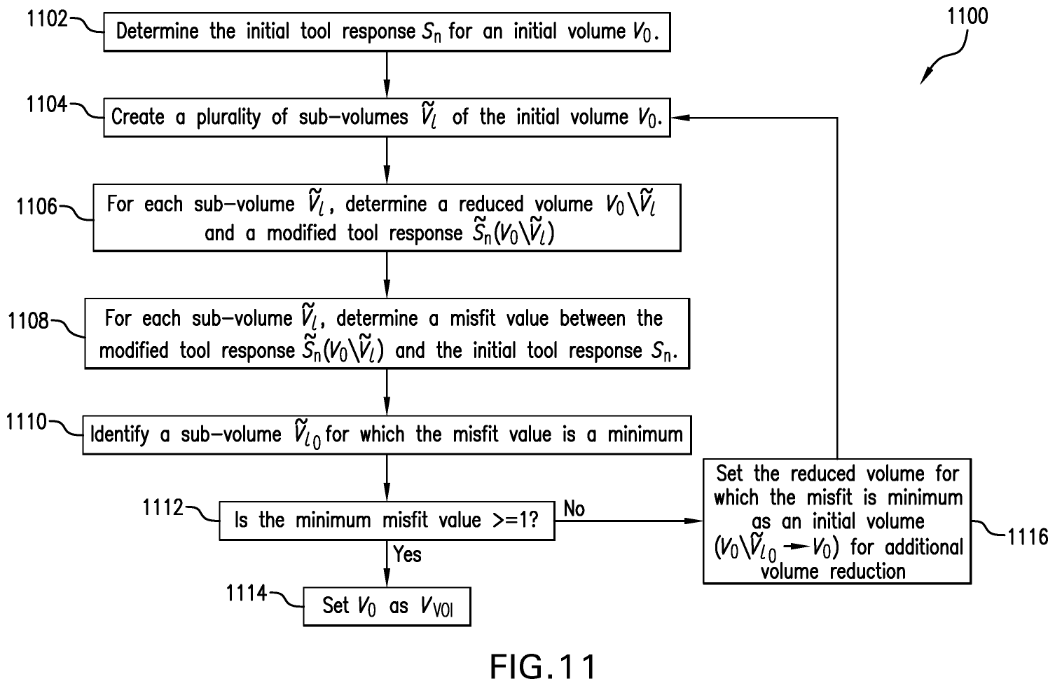

FIG. 11 shows a flowchart 1100 of the response-based approach for determining the shape of the volume of investigation V_{VOI} from the initial volume V₀. In box 1102, initial tool responses Sₙ(V₀) are determined for the initial volume V₀:

$${S}_{n} = {f}_{n} ( {\{ {U}_{ps} \}}_{n} ) , n = 1 , … , N \qquad Eq . ( 17 )$$

In box 1104, a plurality of sub-volumes \tilde{V}₁ are defined over the initial volume V₀. In box 1106, a plurality of modified tool responses is calculated. Each modified tool response is the tool response from a reduced volume V₀\\tilde{V}ₗ corresponding to the initial volume minus a respective sub-volume. For example,

the modified tool response for the l-th reduced volume is denoted by Eq. (18):

$${\tilde{S}}_{n} ( {V}_{0} \backslash {\tilde{V}}_{l} ) = {f}_{n} ( {\{ {U}_{ps} - Δ {U}_{{\tilde{V}}_{l} , ps} \}}_{n} ) \qquad Eq . ( 18 )$$

$$where$$

$$Δ {U}_{{\tilde{V}}_{l} , ps} = {\sum }_{{V}_{k} ∈ {\tilde{V}}_{l}} Δ {U}_{{V}_{k} , ps} \qquad Eq . ( 19 )$$

In box 1108, a misfit value is determined for each reduced volume. The misfit value is based on a difference between the modified tool response (\tilde{S}ₙ (V₀\Vₗ)) for the trial and tool response for the initial volume (Sₙ), as shown in Eq. (20):

$${msft}_{l} = {max}_{n} ( \frac{\vert {\tilde{S}}_{n} ( {V}_{0} \backslash {\tilde{V}}_{l} ) - {S}_{n} \vert}{{α}_{n} \cdot \vert {S}_{n} \vert + {δ}_{n}} ) \qquad Eq . ( 20 )$$

where αₙ and δₙ are the relative and absolute tool measurement errors, respectively. In a generalized form the misfit value may be calculated as shown in Eq. (21):

$${msft}_{l} = ‖ W ( {S}_{n} , noise ) ( {\tilde{S}}_{n} ( {V}_{0} \backslash {\tilde{V}}_{l} ) - {S}_{n} ) \qquad Eq . ( 21 )$$

where W is a matrix of weights depending on the EM tool error model.

It is understood that the tool error model for the misfit calculation is only a particular example and can be chosen arbitrarily.

In box 1110, the sub-volume for which the misfit value is minimum is identified, as shown in Eq. (22):

$${msft}_{{l}_{0}} = {min}_{l} ( {msft}_{l} ) \qquad Eq . ( 22 )$$

In box 1112, if the minimum misfit value is greater than or equal to 1 (msftₗ_{₀}≥1), the method proceeds to box 1114. In box 1114, the method ends, with the initial volume V₀ being selected as the volume of interest V_{VOI} (i.e., V₀→V_{VOI}) Returning to box 1112, if the minimum misfit value is less than 1, the method proceeds to box 1116. In box 1116, the sub-volume having the minimum misfit value is removed to create the intermediate volume, which is used as input to the next stage. The method then returns to box 1104.

FIG. 12 is a diagram 1200 depicting stages for constructing a volume of investigation using a generalized response-based approach. The diagram 1200 depicts an initial volume configuration 1202 that includes the initial volume V₀ 1204 divided into cells and an initial volume of interest V_{VOI} 1206 constructed within the initial volume V₀ 1204. The initial volume of interest may be defined by the response-based approach as illustrated in FIGS. 7 to 11. A constant resistivity ρ₀ is defined throughout the cells of the initial volume V₀ 1204 that are not included in the initial volume of interest V_{VOI} 1206 and predefined resistivity distribution ρ(r) is defined within the initial volume of interest V_{VOI} 1206.

The initial volume of interest V_{VOI} 1206 has an interface 1208 in common with at least one of the sub-volumes \tilde{V}ₗ of the initial volume configuration V₀ 1202. For each sub-volume \tilde{V}ₗ that has a common boundary with the V_{VOI}, a new model is constructed by changing the resistivity of the sub-volume from the constant resistivity ρ₀ to the predefined resistivity distribution ρ(r). For example, in Stage 1, a first modified volume configuration 1210 differs from the initial volume configuration 1202 by changing the resistivity profile of a first sub-volume \tilde{V}₁ along the interface 1208 from ρ₀ to ρ(r). A second modified volume configuration 1212 differs from the initial volume configuration 1202 by changing the resistivity profile of a second sub-volume V₂ along the interface 1208 from ρ₀ to ρ(r). Though not shown in FIG. 2, additional modified volume configurations can also be created. The modified volume configuration that has the least effect on the response is selected for changing to create a new initial volume configuration.

In Stage 2, the first modified volume configuration 1210 has been accepted as a new initial volume configuration 1214 by accepting the change to resistivity profile of the first sub-volume \tilde{V}₁. The shape of the interface 1208 changes accordingly between stages. During stage 2, a first modified volume configuration 1216 differs from the new initial volume configuration 1214 by changing the resistivity profile of a new first sub-volume \tilde{V}₁ from ρ₀ to ρ(r). A second modified volume configuration 1218 differs from the new initial volume configuration 1214 by changing the resistivity profile of a second sub-volume \tilde{V}₂ from ρ₀ to ρ(r). As with Stage 1, the modified volume configuration that has the least effect on the response is selected for the next stage. This method proceeds through additional stages until a stopping criterion is met.

FIG. 13 shows a flowchart 1300 illustrating a method for determining the VOI using the generalized response-based approach. In box 1302, the input data for the generalized response-based approach is a sequence of tool responses registered at one measure point or at a set of measure points in the trajectory, as shown in Eq. (23):

$${S}_{n} = {f}_{n} ( {\{ {U}_{ps} \}}_{n} ) n = 1 , … , N \qquad Eq . ( 23 )$$

In box 1304, an initial volume of interest V_{VOI} having a defined resistivity distribution ρ(r) is defined within the initial volume V₀. The remaining initial volume V₀\V_{VOI} is divided into a plurality of cells, with a constant resistivity ρ₀ in each of the cells.

In box 1306, a plurality of modified volumes is created from the initial configuration, each modified volume being created by changing the resistivity of a cell bordering the V_{VOI}. As shown in FIG. 12 for illustrative purposes, in a first trial (i.e., first modified volume configuration 1210) of the first stage, the resistivity is changed for a first sub-volume \tilde{V}₁ and, in a second trial (i.e., second modified volume configuration 1212), the resistivity is changed for second sub-volume \tilde{V}₂. Additional trials (not shown) can be performed as well during the first stage.

In box 1306, a corrected response is calculated for each modified volume, as shown in Eq. (24):

$${\tilde{S}}_{n} ( {V}_{VOI} ( ρ ( r ) ) ⋃ {\tilde{V}}_{l} ( ρ ( r ) ) ⋃ {\tilde{V}}_{l} ( {ρ}_{0} ) ) = {f}_{n} ( {\{ Δ {U}_{VOI ( ρ ( r ) ) , ps} + Δ {U}_{{\tilde{V}}_{l} ( ρ ( r ) ) , ps} + Δ {U}_{{\tilde{V}}_{l} ( {ρ}_{0} ) , ps} \}}_{n} ) \qquad Eq . ( 24 )$$

The expression V(ρ) indicates that the volume V has a resisitivity ρ; the volume \check{V}ₗ is obtained as \check{V}₁=V₀\V_{VOI}\\tilde{V}₁. To calculate the response for each modified volume, electric field distributions Eᵢ(r), i=1, . . . , I are obtained either by a rigorous solution or approximate solution to the system using Maxwell's equations.

In box 1308, for each volume \tilde{V}ₗ, 1=1, . . . the misfit between the modified response and the initial tool response may calculated as shown in Eq. (25):

$${msft}_{l} = {max}_{n} ( \frac{\vert {\tilde{S}}_{n} ( {V}_{VOI} ( ρ ( r ) ) ⋃ {\tilde{V}}_{l} ( ρ ( r ) ) ⋃ {\tilde{V}}_{l} ( {ρ}_{0} ) ) - {S}_{n} \vert}{{α}_{n} \cdot \vert {S}_{n} \vert + {δ}_{n}} ) \qquad Eq . ( 25 )$$

where αₙ and δₙ are the relative and absolute tool measurements errors, respectively, and the misfit is based on a difference between the modified response and the initial tool response. In a generalized form the misfit function may be calculated as shown in Eq. (26):

$${msft}_{l} = ‖ W ( {S}_{n} , noise ) ( {\tilde{S}}_{n} ( {V}_{VOI} ( ρ ( r ) ) ⋃ {\tilde{V}}_{l} ( ρ ( r ) ) ⋃ {\tilde{V}}_{l} ( {ρ}_{0} ) ) - {S}_{n} ) ‖ \qquad Eq . ( 26 )$$

where W is a matrix of weights depending on the EM tool error model.

It is understood that the tool error model for the misfit calculation (Eq. (25)) is only a particular example and can be chosen arbitrarily.

In box 1310, the volume \tilde{V}ₗ_{₀} having the minimum misfit is identified, as shown in Eq. (27):

$${msft}_{{l}_{0}} = {min}_{l} ( {msft}_{l} ) \qquad Eq . ( 27 )$$

In box 1312, if the minimum misfit value is greater than 1, the method proceeds to box 1316 where the \tilde{V}ₗ_{₀}∪V_{VOI} is chosen as the new initial volume V_{VOI} and then returns to box 1304 and the new initial volume is used in the next stage. Otherwise, if the minimum misfit value is less than or equal to 1 (msftₗ_{₀}≤1), the method proceeds to box 1314. The misfit value being less or equal to 1 is the criterion of the generalized response-based approach. In box 1314, the volume \tilde{V}ₗ_{₀}∪V_{VOI} is used as the modified VOI in the modified volume configuration of stage 2 (new modified volume configuration). A parametric definition of the DoD tube is given by set of radial parameters R₁, . . . , Rₘ, wherein m is the number of angular sectors and the radial parameter values are given by the summation of the radial extends of cells in the defined volume of investigation.

FIG. 14 shows a two-layer formation model or a two-layer resistivity model 1400 with an EM tool 108 disposed therein for use in the field decay-based approach. The two-layer model 1400 includes a first medium 1402 having a first resistivity ρ₁ and a second medium 1404 having a second resistivity ρ₂. The first medium 1402 and the second medium 1404 contact each other at a planar boundary 1406. The EM tool 108 is disposed with the first medium 1402 at a given distance R from the planar boundary 1406 with its longitudinal axis of the tool parallel to the planar boundary 1406.

The value of the second resistivity ρ₂ can be selected in different ways. In one embodiment, the second resistivity can be defined as a value within a constant range bounded by a minimum value and a maximum value. In another embodiment, the second resistivity can be a function of the first resistivity. In yet another embodiment, the second resistivity can be selected based on knowledge about a reservoir or a maximum contrast observed while drilling the borehole or the reservoir. The contrast between the first resistivity ρ₁ and the second resistivity ρ₂ are selected to be large enough to be detectable by the EM tool 108.

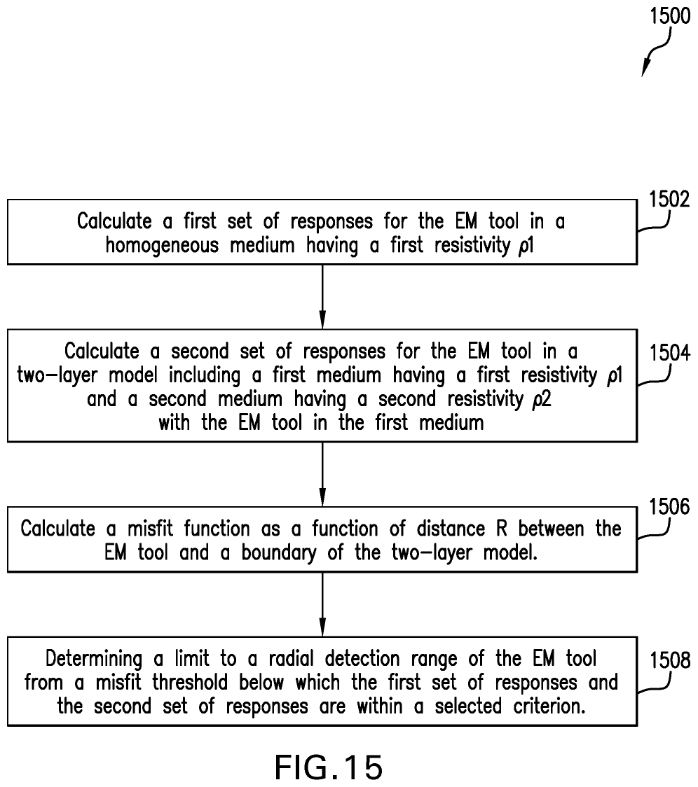

FIG. 15 shows a flowchart 1500 of a method for determining a limit value for a radial detection range of the EM tool 108 using the two-layer model shown in FIG. 14. The limit value of the radial detection range can be determined by comparing a first set of responses for the EM tool 108 in a homogeneous medium to a second set of responses for the EM tool 108 disposed in the two-layer model 1400 shown in FIG. 14. In box 1502, a first set of responses Sₙ, n=1, . . . , N is calculated for the EM tool disposed in the homogeneous medium, equal the first medium. The homogeneous medium has a first resistivity ρ₁. In box 1504, a second set of responses \tilde{S}ₙ(R), n=1, . . . , N is calculated for the EM tool 108 disposed in the first medium 1402 with resistivity ρ₁ of the two-layer model 1400. The second set of responses are calculated as a function of the a distance R between the EM tool 108 and the planar boundary 1406.

In box 1506, a misfit value is determined between the second set of responses and the first set of responses. In an embodiment, the misfit value depending on the distance R can be calculated as shown in Eq. (28):

$$msft ( R ) = \sqrt{{\sum }_{n} {( \frac{\vert {\tilde{S}}_{n} ( R ) - {S}_{n} \vert}{{α}_{n} \cdot \vert {S}_{n} \vert + {δ}_{n}} )}^{2}} \qquad Eq . ( 28 )$$

where αₙ is the relative tool measurement error and δₙ is the absolute tool measurement error. The misfit value is based on a difference between the first set of responses S, and the second set of responses \tilde{S}ₙ(R). In a generalized form the misfit value may be calculated as shown in Eq. (29):

$$msft ( R ) = ‖ W ( {S}_{n} , noise ) ( {\tilde{S}}_{n} ( R ) - {S}_{n} ) ‖ \qquad Eq . ( 29 )$$

where W is a matrix of weights depending on the EM tool error model.

In box 1508, a misfit threshold msft₀ is determined. The misfit threshold is a misfit value below which the second set of responses and the first set of responses are indistinguishable or are within a specific tolerance. The misfit value is commonly set to 1 but can as well be set to a different value. The limit \tilde{R} of the radial detection range (radial detection limit) of the EM tool 108 for a specific ρ₁ and ρ₂, calculated by using Eq. (28 or 29), is found when the misfit threshold is reached, as shown in Eq. (30):

$$msft ( \tilde{R} ) = {msft}_{0} \qquad Eq . ( 30 )$$

If the misfit function meets the misfit threshold, the criterion for having found the limit \tilde{R} of the radial detection range is met. A function of the limit of the radial detection range from the resistivity ρ₁ can be determined by repeating calculations of the radial detection limit for various ρ₁.

A mathematical function of the limit value of the radial detection range from the resistivity (\tilde{R}(ρ)) can be obtained by assigning ρ₁ in the two-layer formation model 1400 to ρ and calculating the corresponding distance \tilde{R} using the equation (28). In addition to the resistivity of a homogeneous medium, the function \tilde{R}(ρ) depends also on the set of tool measurements, the tool error model, the misfit function and the way (see above) for selecting the resistivity ρ₂ in the two-layer model 1400. It is understood that the two-layer model 1400 selected for the misfit calculation is only a particular example and a multiple layer model (i.e., an n-layer model), also referred to herein as multi-layer resistivity model or a multi-layer formation parameter model, can be chosen instead.

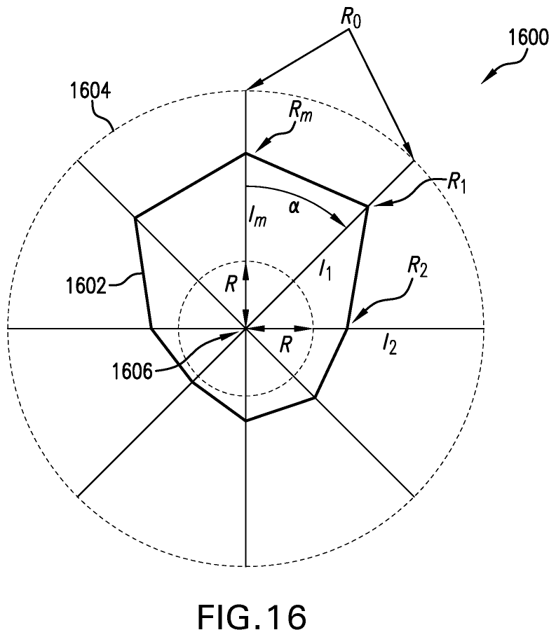

FIG. 16 shows a cross sectional view 1600 of a DoD tube 1602 along a longitudinal axis (trajectory of the EM tool) of the DoD tube 1602, in an illustrative embodiment. The cross section is oriented perpendicular to the longitudinal axis of the DoD tube, the longitudinal axis of the tool and/or the longitudinal axis of the borehole, respectively. The DoD tube 1602 is shown within an initial volume 1604 (V₀) having a radius R₀. The initial volume 1604 (V₀) is a known upper limit of a radial detection range of the EM tool 108 (e.g., 100 meters). The set of radial parameters R₁, R₂, . . . , Rₘ along a set of line segments l₁, l₂, . . . , lₘ. of the DoD tube 1602 are shown extending from a measure point 1606. The line segments lₘ are located in the cross section at different angles α. In an alternative embodiment the line segments lₘ may not be perpendicular to the longitudinal axis of the DoD tube but may form an angle with the longitudinal axis (not shown). The angle may be between 1° and 85°, or may slightly deviate from being perpendicular to the longitudinal axis. The deviation may be between 1° to 4.9° from the perpendicular configuration.

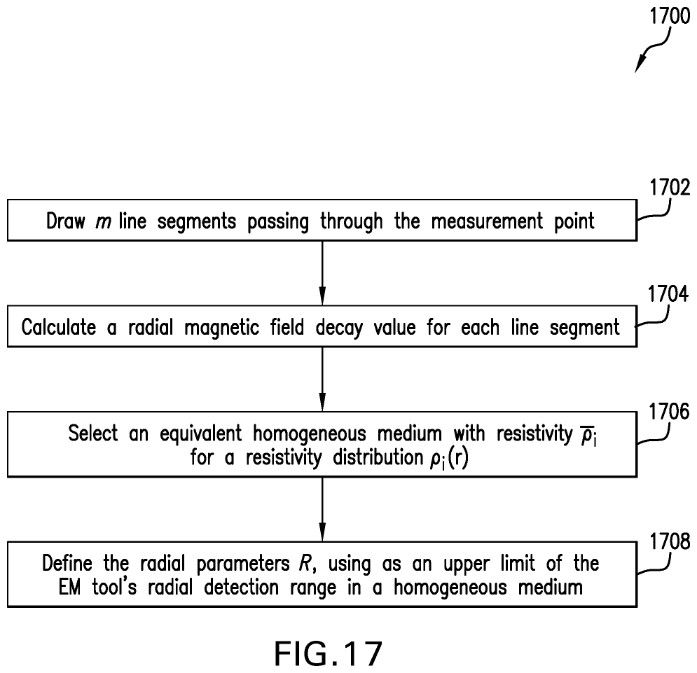

FIG. 17 shows a flowchart 1700 of the field decay-based approach for calculating a set of radial parameters R₁, R₂, . . . , Rₘ of the DoD tube 1602 using a fast approximate algorithm. In the field decay-based approach, the DoD tube 1602 is calculated directly without using cells or sub-volumes.

In box 1702, the set of m line segments l₁, . . . , lₘ are drawn with a length R₀ in the plane passing through the measure point 1606 and oriented perpendicular to the trajectory of the tool or perpendicular to the longitudinal axis of the tool. In box 1704, a radial magnetic field decay function Da (R) is calculated along each line segment lᵢ, i=1, . . . , m, as shown in Eq. (31):

$${D}_{i} ( R ) = {\int }_{0}^{R} Re ( {k}_{i} ( r ) ) dr = {\int }_{0}^{R} \sqrt{\frac{π \cdot f \cdot μ}{{ρ}_{i} ( r )}} dr , R ∈ [ 0 ; {R}_{0} ] \qquad Eq . ( 31 )$$

where kᵢ(r) is a wave number distribution along a line segment lᵢ, ρᵢ(r) is the resistivity distribution in the initial volume (such as a predetermined resistivity distribution) along the line segment lᵢ, R is the length of an arbitrary segment starting at the measure point 1606 and lying on the segment lᵢ, f is the lowest operation frequency of the EM tool 108, and μ is a permeability (magnetic permeability) of the medium surrounding the tool or the borehole. In box 1706, an equivalent homogeneous medium with resistivity \tilde{ρ}ᵢ is selected for each distribution ρᵢ(r) along the line segment lᵢ. The choice of resistivity of an equivalent homogeneous medium can be carried out by solving Eq. (32):

$${D}_{i} ( \tilde{R} ( {\tilde{ρ}}_{i} ) ) = \sqrt{\frac{π \cdot f \cdot μ}{{\tilde{ρ}}_{i}}} \cdot \tilde{R} ( {\tilde{ρ}}_{i} ) \qquad Eq . ( 32 )$$

where the function \tilde{R}(\tilde{ρ}ᵢ) is the upper limit of the radial detection range of the EM tool 108 in a homogeneous medium with respect to the equivalent homogenous medium resistivity \tilde{ρ}ᵢ determined earlier by using Eq. 28 (or Eq. 29) and Eq. 30 ((\tilde{R}(ρ)). Calculating the equivalent homogenous medium resistivity \tilde{ρ}ᵢ for which Eq. (32) is true allows for determining the upper limit of the radial detection range \tilde{R} by using the function (\tilde{R}(ρ) wherein ρ=\tilde{ρ}ᵢ. Eq. (32) represents the criterion in the field decay-based approach for having found the limit \tilde{R} of the upper limit of the radial detection range. The upper limit of the radial detection range depends on the EM tool type (e.g., transmitter, receiver configuration), the operating parameters of the EM tool (e.g. transmitted frequency, power) and the formation parameters (e.g. resistivity). The criterion in Eq. (32) describes an intersection of the decay functions Dᵢ(\tilde{R}(\tilde{ρ}ᵢ)) and

$$\sqrt{\frac{π \cdot f \cdot μ}{{\tilde{ρ}}_{i}}} \cdot \tilde{R} ( {\tilde{ρ}}_{i} ) .$$

In box 1708, the set of radial parameters Rᵢ, i=1, . . . , m (corresponding to the set of line segments lᵢ, i=1, . . . , m) are defined as Rᵢ=\tilde{R}(\tilde{ρ}ᵢ) applying the described approach for all line segments lᵢ. The radial parameters Rᵢ define the radial boundary of the DoD tube in a plane perpendicular to the trajectory of the tool including the measure point 1606. The 3-D DoD tube is generated by combining the radial boundaries of the DoD tube belonging to neighboring measure points. The combining may include an interpolation method or alternative methods. The parameters defining the DoD tube at the position of the measure point are the radial parameters Rᵢ, wherein the i indicates different line segments at different angular position in the cross section of the DoD tube perpendicular to the trajectory and including the measure point associated with an angle α. The number i of angular positions may be smaller or bigger than the eight angular positions shown in FIG. 16 and indicated by lines lᵢ (45° in FIG. 16). The angular positions may be configured regularly (same angular distance between all line segments lᵢ, or may be configured irregularly (varying angular distance between the line segments lᵢ.

Set forth below are some embodiments of the foregoing disclosure:

Embodiment 1. A method of operating a downhole device. The method includes obtaining, using the downhole device, measurements of a formation parameter at a measure point along a trajectory of the downhole device, defining an initial volume surrounding the downhole device, calculating a first radial parameter value using a predetermined formation parameter value distribution in the initial volume, the first radial parameter value representing a distance from the measure point and defining a volume of investigation, and performing the operation of the downhole device using the volume of investigation.

Embodiment 2. The method of any prior embodiment, wherein the predetermined formation parameter value distribution is a predetermined resistivity distribution.

Embodiment 3. The method of any prior embodiment, wherein defining the volume of investigation further comprises segmenting the initial volume into a plurality of cells, assigning a resistivity to a cell of the plurality of cells based on the predetermined resistivity distribution, and including the cell in the volume of investigation when a response of the downhole device meets a criterion.

Embodiment 4. The method of any prior embodiment, wherein the criterion is defined by a misfit function.

Embodiment 5. The method of any prior embodiment, further comprising determining a first volume of investigation for a first measure point and a second volume of investigation for second measure point and constructing a depth of detection tube from the first volume of investigation and the second volume of investigation.

Embodiment 6. The method of any prior embodiment, wherein defining the volume of investigation further comprises segmenting the initial volume into a plurality of cells, assigning a resistivity to a cell of the plurality of cells based on the predetermined resistivity distribution, and including the cell in the volume of investigation when a criterion is met, wherein the criterion includes the skin depth calculated based on the predetermined resistivity distribution.

Embodiment 7. The method of any prior embodiment, wherein the first radial parameter value is calculated by further using a multi-layer formation parameter model including a layer having a value for a first formation parameter, a limit value of a radial detection range in the multi-layer formation parameter model, a first decay function, wherein the first decay function depends on the predetermined formation parameter value distribution in the initial volume, and a second decay function, the second decay function depending on the limit value of the radial detection range in the multi-layer formation parameter model.

Embodiment 8. The method of any prior embodiment, wherein the first formation parameter is a resistivity, and the multi-layer formation parameter model is a multi-layer resistivity model, and the predetermined formation parameter value distribution is a predetermined resistivity value distribution.

Embodiment 9. The method of any prior embodiment, wherein the multi-layer resistivity model includes at least two layers with a first layer including a first resistivity and a second layer including a second resistivity and the second resistivity depends on the first resistivity.

Embodiment 10. The method of any prior embodiment, wherein the first formation parameter value includes a plurality of formation parameter values, and the limit value of the radial detection range includes a plurality of limit values of the radial detection range corresponding to the plurality of first formation parameter values.

Embodiment 11. The method of any prior embodiment, wherein the downhole device is surrounded by a depth of investigation tube (DoD) including the volume of investigation, the DoD tube includes a first cross section perpendicular to the trajectory of the downhole device, the first cross section including a first set of line segments, and wherein the DoD tube is defined by a first set of radial parameter values corresponding to the first set of line segments, the first set of radial parameter values including the first radial parameter value.

Embodiment 12. The method of any prior embodiment, wherein the DoD tube includes a second cross section perpendicular to the trajectory of the downhole device, the second cross section including a second set of line segments with a second set of radial parameter values corresponding to the second set of line segments, and wherein the DoD tube is constructed by combining the first set of radial parameter values and the second set of radial parameter values.

Embodiment 13. The method of any prior embodiment, wherein each radial parameter value of the first set of radial parameter values defines a distance between the measure point and an outer surface of the DoD tube, wherein two different radial parameter values of the first set of radial parameter values correspond to two line segments of the first set of line segments located at different angular positions in the first cross section.

Embodiment 14. The method of any prior embodiment, wherein the limit value of the radial detection range is defined using a misfit threshold.

Embodiment 15. The method of any prior embodiment, wherein calculating the first radial parameter value includes a criterion that includes determining a value for the first formation parameter for which the first decay function and the second decay function intersect.

Embodiment 16. A downhole system. The downhole system includes a downhole device configured to obtain measurements of a formation parameter at a measure point along a trajectory of the downhole device, and a processor. The processor is configured to define an initial volume surrounding the downhole device, calculate a first radial parameter value using a predetermined formation parameter value distribution in the initial volume, the first radial parameter value representing a distance from the measure point and defining a volume of investigation, and perform the operation of the downhole device using the volume of investigation.

Embodiment 17. The downhole system of any prior embodiment, wherein the predetermined formation parameter value distribution is a predetermined resistivity distribution and the processor is further configured to determine the volume of investigation by segmenting the initial volume into a plurality of cells, assigning a resistivity to a cell of the plurality of cells based on the predetermined resistivity distribution, and including the cell in the volume of investigation when a response of the downhole device meets a criterion.

Embodiment 18. The downhole system of any prior embodiment, wherein the predetermined formation parameter value distribution is a predetermined resistivity distribution and the processor is configured to determine the volume of investigation by segmenting the initial volume into a plurality of cells, assigning a resistivity to a cell of the plurality of cells based on the predetermined resistivity distribution, and including the cell in the volume of investigation when a criterion is met, wherein the criterion includes the skin depth calculated based on the predetermined resistivity distribution.

Embodiment 19. The downhole system of any prior embodiment, wherein the processor is further configured to calculate the first radial parameter value using a multi-layer formation parameter model including a layer having a value for a first formation parameter, a limit value of a radial detection range in the multi-layer formation parameter model, a first decay function, wherein the first decay function depends on the predetermined formation parameter value distribution in the initial volume, and a second decay function, the second decay function depending on the limit value of the radial detection range in the multi-layer formation parameter model.

Embodiment 20. The downhole system of any prior embodiment, wherein the processor is further configured to calculate the first radial parameter value by determining a value for the first formation parameter for which the first decay function and the second decay function intersect.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may include, but are not limited to, formation evaluation, reservoir navigating, geo-steering, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of operating a downhole device, comprising:
obtaining, using the downhole device, measurements of a formation parameter at a measure point along a trajectory of the downhole device;
defining an initial volume surrounding the downhole device;
calculating a first radial parameter value using a predetermined formation parameter value distribution in the initial volume, the first radial parameter value representing a distance from the measure point and defining a volume of investigation; and
performing the operation of the downhole device using the volume of investigation.

2. The method of claim 1, wherein the predetermined formation parameter value distribution is a predetermined resistivity distribution.

3. The method of claim 2, wherein defining the volume of investigation further comprises segmenting the initial volume into a plurality of cells, assigning a resistivity to a cell of the plurality of cells based on the predetermined resistivity distribution, and including the cell in the volume of investigation when a response of the downhole device meets a criterion.

4. The method of claim 3, wherein the criterion is defined by a misfit function.

5. The method of claim 2, further comprising determining a first volume of investigation for a first measure point and a second volume of investigation for second measure point and constructing a depth of detection tube from the first volume of investigation and the second volume of investigation.

6. The method of claim 2, wherein defining the volume of investigation further comprises segmenting the initial volume into a plurality of cells, assigning a resistivity to a cell of the plurality of cells based on the predetermined resistivity distribution, and including the cell in the volume of investigation when a criterion is met, wherein the criterion includes the skin depth calculated based on the predetermined resistivity distribution.

7. The method of claim 1, wherein the first radial parameter value is calculated by further using:
a multi-layer formation parameter model including a layer having a value for a first formation parameter,
a limit value of a radial detection range in the multi-layer formation parameter model,
a first decay function, wherein the first decay function depends on the predetermined formation parameter value distribution in the initial volume, and
a second decay function, the second decay function depending on the limit value of the radial detection range in the multi-layer formation parameter model.

8. The method of claim 7, wherein the first formation parameter is a resistivity, and the multi-layer formation parameter model is a multi-layer resistivity model, and the predetermined formation parameter value distribution is a predetermined resistivity value distribution.

9. The method of claim 8, wherein the multi-layer resistivity model includes at least two layers with a first layer including a first resistivity and a second layer including a second resistivity and the second resistivity depends on the first resistivity.

10. The method of claim 7, wherein the first formation parameter value includes a plurality of formation parameter values, and the limit value of the radial detection range includes a plurality of limit values of the radial detection range corresponding to the plurality of first formation parameter values.

11. The method of claim 7, wherein the downhole device is surrounded by a depth of investigation tube (DoD) including the volume of investigation, the DoD tube includes a first cross section perpendicular to the trajectory of the downhole device, the first cross section including a first set of line segments, and wherein the DoD tube is defined by a first set of radial parameter values corresponding to the first set of line segments, the first set of radial parameter values including the first radial parameter value.

12. The method of claim 11, wherein the DoD tube includes a second cross section perpendicular to the trajectory of the downhole device, the second cross section including a second set of line segments with a second set of radial parameter values corresponding to the second set of line segments, and wherein the DoD tube is constructed by combining the first set of radial parameter values and the second set of radial parameter values.

13. The method of claim 11, wherein each radial parameter value of the first set of radial parameter values defines a distance between the measure point and an outer surface of the DoD tube, wherein two different radial parameter values of the first set of radial parameter values correspond to two line segments of the first set of line segments located at different angular positions in the first cross section.

14. The method of claim 7, wherein the limit value of the radial detection range is defined using a misfit threshold.

15. The method of claim 7, wherein calculating the first radial parameter value includes a criterion that includes determining a value for the first formation parameter for which the first decay function and the second decay function intersect.

16. A downhole system, comprising:
a downhole device configured to obtain measurements of a formation parameter at a measure point along a trajectory of the downhole device;
a processor configured to:
define an initial volume surrounding the downhole device;
calculate a first radial parameter value using a predetermined formation parameter value distribution in the initial volume, the first radial parameter value representing a distance from the measure point and defining a volume of investigation; and
perform the operation of the downhole device using the volume of investigation.

17. The downhole system of claim 16, wherein the predetermined formation parameter value distribution is a predetermined resistivity distribution and the processor is further configured to determine the volume of investigation by segmenting the initial volume into a plurality of cells, assigning a resistivity to a cell of the plurality of cells based on the predetermined resistivity distribution, and including the cell in the volume of investigation when a response of the downhole device meets a criterion.

18. The downhole system of claim 16, wherein the predetermined formation parameter value distribution is a predetermined resistivity distribution and the processor is configured to determine the volume of investigation by segmenting the initial volume into a plurality of cells, assigning a resistivity to a cell of the plurality of cells based on the predetermined resistivity distribution, and including the cell in the volume of investigation when a criterion is met, wherein the criterion includes the skin depth calculated based on the predetermined resistivity distribution.

19. The downhole system of claim 16, wherein the processor is further configured to calculate the first radial parameter value using:
a multi-layer formation parameter model including a layer having a value for a first formation parameter;
a limit value of a radial detection range in the multi-layer formation parameter model;
a first decay function, wherein the first decay function depends on the predetermined formation parameter value distribution in the initial volume; and
a second decay function, the second decay function depending on the limit value of the radial detection range in the multi-layer formation parameter model.

20. The downhole system of claim 19, wherein the processor is further configured to calculate the first radial parameter value by determining a value for the first formation parameter for which the first decay function and the second decay function intersect.
